(19) United States
(12) Patent Application Publication
(10) Pub. No.: US 2025/0249866 A1
(43) Pub. Date: Aug. 7, 2025

(54) SYSTEM AND METHOD FOR FLUID DISPERSION

(71) Applicant: Volvo Autonomous Solutions AB, Göteborg (SE)

(72) Inventor: Benjamin HANSON, Fayetteville, PA (US)

(73) Assignee: Volvo Autonomous Solutions AB, Göteborg (SE)

(21) Appl. No.: 18/853,227

(22) PCT Filed: Apr. 8, 2022
(86) PCT No.: PCT/EP2022/059404

§ 371 Date: Oct. 1, 2024

(51) Int. Cl. B60S 1/48; B60S 1/50; B60S 1/52

(52) U.S. Cl. CPC B60S 1/481; B60S 1/50; B60S 1/52

(57) ABSTRACT

A fluid dispersion system for a vehicle, adapted to feed fluid to a plurality of fluid nozzles, has a fluid reservoir arranged to hold the fluid, a pressure accumulator tank arranged to hold pressurized fluid, a pump arranged to supply the pressure accumulator tank with pressurized fluid, a first type of fluid nozzle provided with a controllable valve connected to the pressure accumulator tank, and an electronic control unit arranged to control the pump and the controllable valve. The pump has a controllable backflow valve connected to a windshield washer nozzle. The backflow valve is closed as default, and the electronic control unit is arranged to open the backflow valve of the pump in dependency of an open signal.

### TECHNICAL FIELD

The present invention relates to a system and method for fluid dispersion at a vehicle, and preferably for an autonomous vehicle having a plurality of sensors, where at least some of the sensors are provided with a fluid nozzle. The system and method will reduce the amount of components used in such a system.

### BACKGROUND ART

Vehicles are being provided with more and more sensors arranged to detect objects in the close vicinity of the vehicle. Some sensors are arranged to increase the safety of the vehicle, e.g. to measure the distance to a vehicle in front of the ego vehicle, or to detect if the vehicle is approaching the side lines of a lane. Other sensors are used to give a detailed view of the surrounding of the vehicle, in order to provide the vehicle with some type of autonomy, such that the vehicle will be able to drive autonomously at at least some parts of a road.

Some of these sensors, e.g. cameras, depend on a clear view to be able to give a clear signal that is useful to the control system. In order to provide a reliable function, the sensors must thus not be contaminated or dirty. The vehicle is for this reason provided with a cleaning system arranged to clean the sensors when required. Most often, a cleaning fluid such as water or a windscreen washer fluid is used to clean the sensors, where a nozzle is arranged close to the sensor. A pressurized fluid is sprayed on the sensor at a high pressure such that the contamination or dirt is removed from the sensor, similar to a headlamp cleaning system of the vehicle.

In order to reduce the amount of components and the cost of the system, each sensor nozzle is not provided with its own pressure pump. Instead, each sensor nozzle is provided with a controllable valve that can be opened when fluid is to be sprayed on the sensor. The fluid to a nozzle is provided from a pressurized accumulator tank, which will provide fluid with a sufficient high pressure. A vehicle is provided with at least one pressurized accumulator tank, and could be provided with more than one pressurized accumulator tank, depending on e.g. the layout of the cleaning system. The pressurized fluid to the pressurized accumulator tank is provided with a pressure pump that is connected to a fluid reservoir, e.g. the existing container holding the windscreen washer fluid of the vehicle. The windscreen washer fluid to the windscreen nozzles is provided with a dedicated windscreen pump arranged in or close to the fluid reservoir.

The problem of cleaning additional sensors is well known.

EP 3615391 B1 discloses a cleaning system comprising a pressure reservoir, where all fluid nozzles of the vehicle are supplied with pressurized fluid from the pressure reservoir through separate controllable valves. The pressurized fluid is fed to the pressure reservoir by a high-pressure pump.

US 2020/0180567 A1 discloses a cleaning system where a pump feeds pressurized fluid to a plurality of nozzles, and where each nozzle is provided with a controllable valve that is opened when a nozzle needs fluid.

These systems work fine, but there is still room for an improved cleaning system for a vehicle.

### DISCLOSURE OF INVENTION

An object of the invention is therefore to provide a fluid dispersion system for a vehicle. A further object of the invention is to provide a method for dispersing a fluid on a vehicle. A further object of the invention is to provide a vehicle comprising such a system. An object is also to provide a computer program and a computer program product adapted to perform the steps of the method.

The solution to the problem according to the invention is described in the characterizing part of claim 1 regarding the system, in claim 10 regarding the method and in claim 13 regarding the vehicle. The other claims contain advantageous further developments of the inventive system and method. Claims for a computer program and a computer program product are also enclosed.

In the inventive fluid dispersion system for a vehicle, adapted to feed fluid to a plurality of fluid nozzles, comprising a fluid reservoir arranged to hold the fluid, a pressure accumulator tank arranged to hold pressurized fluid, a pump arranged to supply the pressure accumulator tank with pressurized fluid, a first type of fluid nozzle provided with a controllable valve connected to the pressure accumulator tank and an electronic control unit arranged to control the pump and the controllable valve, the object of the invention is achieved in that the pump further comprises a controllable backflow valve connected to a windscreen washer nozzle, where the backflow valve is closed as default, and where the electronic control unit is arranged to open the backflow valve of the pump in dependency of an open signal.

With the inventive system, a cleaning system for a vehicle is provided. The vehicle may be an autonomous vehicle having a level of driving automation of e.g. level 2, 3 or 4. The higher level of automation, the more sensors will be used on the vehicle. In the system, the windscreen nozzle is supplied with fluid from a pressurized accumulator tank through a controllable backflow valve in the pump, and the sensor nozzles are supplied with fluid from the pressurized accumulator tank through controllable valves connected to the sensor nozzles. In this way, there is no need for a separate controllable valve for the windscreen nozzle, which simplifies the system. The headlights may in one example also be supplied with fluid from the backflow valve, i.e. the headlamp nozzles may be connected in parallel to the windscreen nozzle.

The pump is connected to a fluid supply reservoir, e.g. a windscreen washer tank, where the cleaning fluid is stored. The fluid reservoir is normally vented, having an ambient pressure. The pump is preferably a high pressure pump, supplying a pressure of between 5-10 bars and a fluid flow of at least 2 litres/min. The pump will supply pressurized fluid to the pressurized accumulator tank. Each sensor nozzle is connected to the pressurized accumulator tank. In this way, each sensor nozzle must not be supplied by a separate pump. Each nozzle or nozzle group is provided with a controllable valve that will open when the nozzle is to spray a cleaning fluid on the sensor. The controllable valve is preferably arranged close to the pressurized accumulator tank. This will reduce the idle pressure in the pressure lines connecting the pressurized accumulator tank to the nozzles.

A pressure sensor arranged at the pump outlet or in the pressurized accumulator tank will monitor the pressure in the pressurized accumulator tank, and will start the pump when the pressure is below a predefined value. In this way, the pressurized accumulator tank will always be able to deliver pressurized fluid to the sensor nozzles and to the windscreen nozzle.

The windscreen nozzle is connected to a controllable backflow valve that is installed in the pump or in the supply line to the pump. The backflow valve is arranged as an overpressure valve that will open at a predefined pressure in order to protect the pressurized accumulator tank from an excessive pressure. The backflow valve can also be controlled by an electronic control unit to open at other pressure values. The backflow valve is used to supply the windscreen nozzles with cleaning fluid. When the driver wants to clean the windscreen, he pushes the washer button and the ECU will open the backflow valve such that cleaning fluid is supplied to the windscreen nozzles. By using an existing controllable backflow valve, the system is simplified.

The fluid reservoir may also be an airtight container which is pressurized by an external pressure source, e.g. from a compressor of the vehicle. In this way, the fluid reservoir may be pressurized at a low pressure, e.g. 2 bars, such that the pump must only rise the pressure level to a lesser degree.

In a method for dispersing a pressurized fluid to a first fluid nozzle type and a second fluid nozzle type on a vehicle, where the first type of fluid nozzle is connected to a pressure accumulator tank through a controllable valve, and where the second type of fluid nozzle is connected to the pressure accumulator tank through a controllable backflow valve in a pump, the steps of; supplying pressurized fluid to the pressure accumulator tank from a fluid reservoir with the pump; opening a controllable valve to supply pressurized fluid to the first type of fluid nozzle when a first signal is issued; and opening the backflow valve of the pump to supply pressurized fluid to the second type of fluid nozzle when a second signal is issued are comprised.

By this first embodiment of the method, the method allows the cleaning of various sensors without the need for a plurality of pressure pumps. By using an existing controllable backflow valve of the pressure pump, a simplified cleaning system is obtained.

### BRIEF DESCRIPTION OF DRAWINGS

The invention will be described in greater detail in the following, with reference to the attached drawings, in which

FIG. 1 shows a schematic example of a vehicle provided with a fluid dispersion system,

FIG. 2 shows a schematic example of a fluid dispersion system, and

FIG. 3 shows a schematic flow chart of the inventive method.

### MODES FOR CARRYING OUT THE INVENTION

The embodiments of the invention with further developments described in the following are to be regarded only as examples and are in no way to limit the scope of the protection provided by the patent claims.

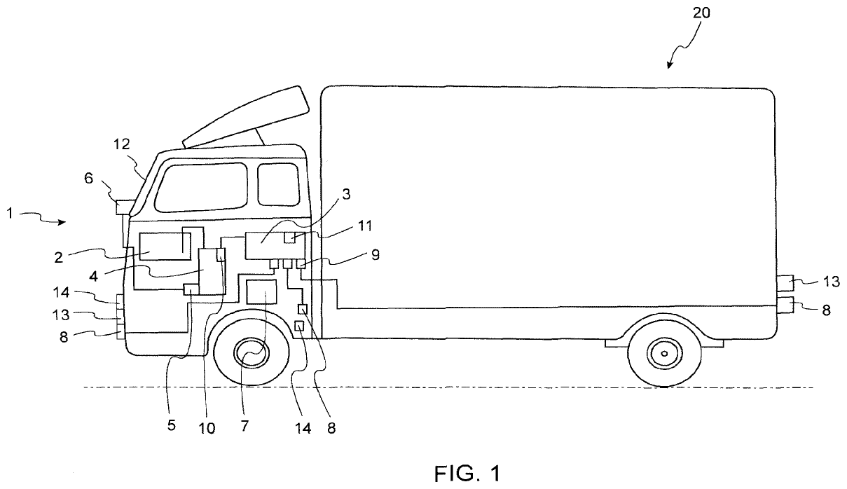

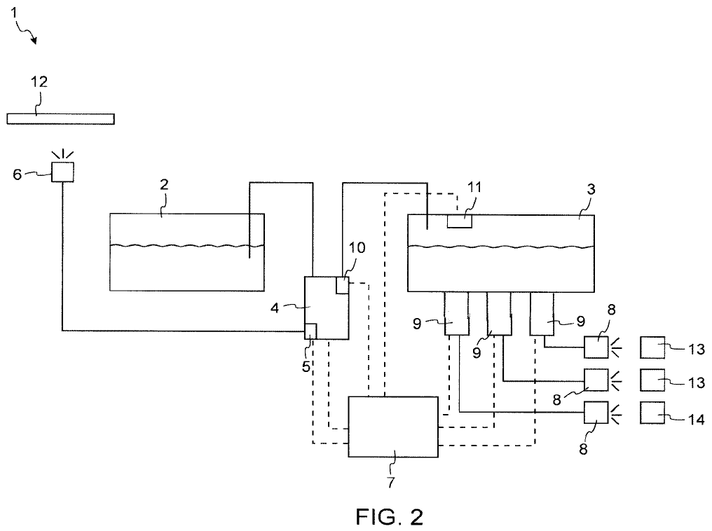

FIG. 1 shows a schematic vehicle 20 provided with an inventive system 1, and FIG. 2 shows an inventive system for fluid dispersion for a vehicle where the system is adapted to supply a plurality of nozzles with pressurized cleaning fluid. In this way, the windshield can be cleaned as usual, and the windshield pressure pump can be used to pressurize an accumulator tank arranged to supply sensor nozzles with pressurized fluid. Controllable valves are controlled by an electronic control unit (ECU) such that selected sensors can be cleaned when required.

The system 1 comprises a fluid reservoir 2 arranged to hold the cleaning fluid and is preferably the ordinary windshield washer reservoir. The reservoir may e.g. hold 4 to 10 litres of cleaning fluid or more. The fluid reservoir is in one example vented, i.e. having an ambient pressure. The system further comprises a pressure accumulator tank 3 arranged to hold pressurized fluid. The pressurized fluid is supplied from the fluid reservoir by a pressure pump 4, e.g. a conventional windshield washer pump. The pressure pump is selected such that the pressure and the capacity fulfils the need of the vehicle.

Normally, the windscreen pump is controlled to supply pressurized cleaning fluid when a wiper washer stalk is operated by a driver. Here, the pump is controlled by the ECU to supply pressurized fluid to the pressurized accumulator tank 3. The pressure in the pressurized accumulator tank is held at a predefined pressure range, e.g. between 6 to 8 bars. A pressure sensor is used to measure the pressure in the pressurized accumulator tank 3. The pressure sensor may be a pressure sensor 10 arranged in the pump, measuring the outlet pressure of the pump. The pressure sensor may also be a pressure sensor 11 arranged in the pressurized accumulator tank, measuring the pressure in the tank.

The pressure pump 4 is provided with a controllable backflow valve 5. The backflow valve is arranged to open at a predefined high pressure in order to protect the cleaning system from excessive pressure. The predefined pressure is higher than the desired working pressure of the system, and may e.g. be set to 10 or 12 bars. The backflow valve is also controllable by the ECU such that pressure can be released from the system if required for other reasons or at other pressure levels. Here, the controllable backflow valve is also used to supply cleaning fluid to the windscreen washer nozzle.

The system comprises a first type of nozzles 8 arranged to clean different sensors of the vehicle. The sensors may include a radar sensor, a camera 13, a laser sensor 14, an infrared sensor, an ultrasonic sensor or any other sensor where the signal is impaired by an unclean sensor surface. The cleaning interval of a sensor may be determined e.g. by estimations on the input signal or by input from other sensors, e.g. from a rain sensor. It is also possible to clean the sensors at given time intervals or e.g. when the windscreen wiper is used.

The first type of nozzles 8 are connected to the pressurized accumulator tank through controllable valves 9. The controllable valves are preferably arranged close to the pressurized accumulator tank 3. In this way, the pressure lines between the controllable valves and the nozzles will not be exposed to a constant high pressure, which will reduce the risk of leakage and will simplify the system. Several nozzles may be supplied with cleaning fluid through the same controllable valve.

The system also comprises a second type of nozzle, which is the windscreen washer nozzle or nozzles 6, and which is connected to the backflow valve 5 of the pump. By opening the backflow valve, fluid is allowed to flow from the pressurized accumulator tank through the pump and the backflow valve to the windscreen nozzle 6 that will spray cleaning fluid on the windscreen 12. It is also possible to connect the headlight nozzles in parallel with the windscreen nozzle. The backflow valve is closed as default, and can be opened by a signal from the wiper washer stalk when operated by a driver, which sends a signal to the ECU that opens the backflow valve.

In an example, the fluid reservoir may also be an airtight container which is pressurized by an external pressure source, e.g. from a compressor of the vehicle. In this way, the fluid reservoir may be pressurized at a low pressure, e.g. 2 to 4 bars. In this way, the engagement time of the pump may be reduced. The external pressure may e.g. be supplied by an existing compressor of the vehicle.

In order to balance the system, such that the required pressure and fluid volume is used for each nozzle and thus for cleaning each sensor, some pressure lines may be provided with restriction means that will reduce the pressure and/or volume of that pressure line. In this way, the same pressurized accumulator tank can be used for different types of nozzles and sensors.

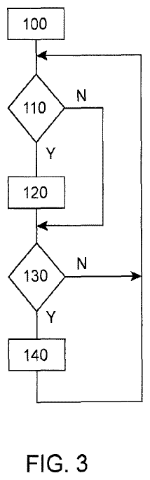

FIG. 3 shows a schematic flow chart of one example of the method for dispersing a pressurized fluid to a first fluid nozzle type and a second fluid nozzle type on a vehicle. The first type of fluid nozzle, here a sensor nozzle, is connected to a pressure accumulator tank through a controllable valve. The second type of fluid nozzle, here a windscreen washer nozzle, is connected to the pressure accumulator tank through a controllable backflow valve in a pump.

In step 100, a pressurized fluid is supplied to the pressure accumulator tank from a fluid reservoir with the pressure pump.

In step 110, it is determined if a first signal is issued, where the first signal is a signal that will open a controllable valve to supply pressurized fluid to the first type of fluid nozzle from the pressurized accumulator tank. If a first signal is issued, the controllable valve is opened in step 120. If a first signal is not issued, the method continues with step 130. The first signal may be issued by an autonomous control system of the vehicle, e.g. in dependency of a climate input or environmental input, such as temperature, humidity etc.

In step 130, it is determined if a second signal is issued, where the second signal is a signal that will open a controllable backflow valve of the pump to supply pressurized fluid to the second type of fluid nozzle from the pressurized accumulator tank. If a second signal is issued, the controllable backflow valve is opened in step 140. If a second signal is not issued, the method returns to step 110 and the method steps are repeated. The second signal may be issued by a driver of the vehicle when a windscreen wiper stalk is operated.

The invention is not to be regarded as being limited to the embodiments described above, a number of additional variants and modifications being possible within the scope of the subsequent patent claims.

### REFERENCE SIGNS

1: Fluid dispersion system
2: Fluid reservoir
3: Pressure accumulator tank
4: Pump
5: Controllable backflow valve
6: Windscreen washer nozzle
7: Electronic control unit
8: Fluid nozzle
9: Controllable valve
10: Pump pressure sensor
11: Tank pressure sensor
12: Windscreen
13: Camera
14: Lidar
20: Vehicle

1. Fluid dispersion system for a vehicle, adapted to feed fluid to a plurality of fluid nozzles, comprising a fluid reservoir arranged to hold the fluid, a pressure accumulator tank arranged to hold pressurized fluid, a pump arranged to supply the pressure accumulator tank with pressurized fluid, a first type of fluid nozzle provided with a controllable valve connected to the pressure accumulator tank, and an electronic control unit arranged to control the pump and the controllable valve, wherein the pump further comprises a controllable backflow valve connected to a windscreen washer nozzle, where the backflow valve is closed as default, and where the electronic control unit is arranged to open the backflow valve of the pump in dependency of an open signal.

2. System according to claim 1, wherein a fluid nozzle is provided with a fluid restrictor arranged to limit the fluid flow through the nozzle.

3. System according to claim 1, wherein the fluid reservoir is a vented reservoir having an ambient pressure.

4. System according to claim 1, wherein the fluid reservoir is an airtight reservoir arranged to be pressurized from an external pressure source.

5. System according to claim 1, wherein the pump is provided with a pressure sensor at the outlet of the pump.

6. System according to claim 1, wherein the pressure accumulator tank is provided with an internal pressure sensor.

7. Vehicle, comprising a system according to claim 1.

8. Method for dispersing a pressurized fluid to a first fluid nozzle type and a second fluid nozzle type on a vehicle, where the first type of fluid nozzle is connected to a pressure accumulator tank through a controllable valve, and where the second type of fluid nozzle is connected to the pressure accumulator tank through a controllable backflow valve in a pump, comprising the following steps:
supplying pressurized fluid to the pressure accumulator tank from a fluid reservoir with the pump,
opening a controllable valve to supply pressurized fluid to the first type of fluid nozzle when a first signal is issued, and
opening the backflow valve of the pump to supply pressurized fluid to the second type of fluid nozzle when a second signal is issued.

9. Method according to claim 8, wherein the first type of fluid nozzle is a spray nozzle for a sensor.

10. Method according to claim 9, wherein a sensor is a radar sensor, a camera, a laser sensor, an infrared sensor or an ultrasonic sensor.

11. Method according to claim 8, wherein the second type of fluid nozzle is a windscreen washer nozzle.

12. Method according to claim 8, wherein the first signal is issued by an autonomous control system of the vehicle.

13. Method according to claim 8, wherein the second signal is issued by a driver of the vehicle.

14. A computer program comprising program code means for performing all the steps of claim 8 when said program is run on a computer.

15. A non-transitory computer program product comprising program code stored on a computer readable medium for performing the steps of claim 8 when said program code is run on a computer.
